(19) United States
(12) Patent Application Publication
(10) Pub. No.: US 2019/0332969 A1
(43) Pub. Date: Oct. 31, 2019

(54) CONFIGURING APPARATUS, METHOD, PROGRAM AND STORING MEDIUM, AND LEARNING DATA ACQUIRING APPARATUS AND METHOD

(71) Applicant: OMRON Corporation, Kyoto-shi, KYOTO (JP)

(72) Inventor: Tanichi ANDO, Komaki-shi (JP)

(73) Assignee: OMRON Corporation, Kyoto-shi, KYOTO (JP)

(21) Appl. No.: 16/462,118

(22) PCT Filed: Feb. 24, 2016
(86) PCT No.: PCT/IB2017/051074

§ 371 Date: May 17, 2019

(51) Int. Cl. G06N 20/00

(52) U.S. Cl. CPC G06N 20/00

(57) ABSTRACT

The present relates to a configuring apparatus, method, program, and storing medium, and a learning data acquiring apparatus and method. The configuring apparatus is used for configuring a learning object for acquiring learning data, a data collecting apparatus collecting learning data from the learning object, and an operating apparatus capable of operating the learning object and the data collecting apparatus. The configuring apparatus includes: a configuring instruction generating portion generating a configuring instruction about at least one of the learning object, the data collecting apparatus, and the operating apparatus according to learning condition information, the learning condition information being information generated according to commission information of user commissioned learning; and an executing portion configuring at least of one the learning object, the data collecting apparatus, and the operating apparatus according to the configuring instruction so as to complete an environment configuration for generating learning data.

### TECHNICAL FIELD

The present invention relates to the field of deep learning, and more particularly to a configuring apparatus, method, program and storing medium, and a learning data acquiring apparatus and method.

### BACKGROUND ART

In recent years, artificial intelligence (AI) technologies represented by deep learning make constant progresses, and technologies such as classifying and predicting an analysis object based on input data such as a camera image and sensor data start to be popularized. By using such AI technology as the deep learning technology, a machine may obtain capabilities such as classifying the analysis object through automatic learning.

With the rapid development of the AI technology, capabilities that may be obtained by the machine as a learning result are more and more broad. Consequently, more users wish to use learning such as the deep learning technology to train machines for obtaining interested capabilities.

Recently, a device (e.g. the classification machine in Patent document 1) capable of classifying or identifying objects involved in images by means of machine learning and using the image data as learning data has been proposed.

### PRIOR ART DOCUMENTS

### Patent Documents

Patent document 1: JP laid-open publication No. 2016-40650

### SUMMARY OF THE INVENTION

### Technical Problems to be Solved

When the deep learning is performed, the learning should be performed based on a lot of learning data. However, preparation of learning data wastes time and energy. Particularly, in a situation where a data collecting apparatus collecting learning data from a learning object comprises a plurality of cameras and a plurality of sensor, etc., and an operating apparatus performing operation on the learning object and the data collecting apparatus comprises a plurality of robots, when collecting the learning data each time, cooperative configurations of those cameras, sensors, and robots are required. This brings great burden to users, and the configuration accuracy cannot be ensured.

For example, a learning machine (classification machine) capable of performing high-precision classification of images is disclosed in the above Patent document 1. In order to constitute such a learning machine, it is required to collect vast and various learning data, and input those learning data to the learning machine according to the capabilities to be obtained by the learning machine as required. However, the collection and input of those vast and various learning data shall be completed manually, thereby wasting time and manpower.

One of the technical problems to be solved in the present invention is to provide a configuring apparatus, method, program and storing medium, and a learning data acquiring apparatus comprising the configuring apparatus which may automatically or semi-automatically configure a learning object, a data collecting apparatus and/or an operating apparatus.

### Solutions to Technical Problems

According to an embodiment of the present invention, a configuring apparatus is provided, for configuring a learning object as an objective for acquiring learning data, a data collecting apparatus collecting learning data from the learning object, and an operating apparatus capable of operating the learning object and the data collecting apparatus. The configuring apparatus may comprise: a configuring instruction generating portion which may generate a configuring instruction about at least one of the learning object, the data collecting apparatus, and the operating apparatus according to learning condition information, the learning condition information being information generated according to commission information of user commissioned learning; and an executing portion which may configure at least one of the learning object, the data collecting apparatus, and the operating apparatus according to the configuring instruction so as to complete an environment configuration for generating the learning data.

In the configuring apparatus, optionally, the learning object may comprise a first learning object and a second learning object. The configuring instruction comprises a switching instruction instructing switch from the first learning object to the second learning object, and the executing portion may switch to the second learning object from the first learning object for data collecting after a predetermined quantity of learning data is generated for the first learning object or a predetermined period has elapsed according to the switching instruction.

Optionally, the configuring instruction may comprise orientation information of at least one of the learning object, the operating apparatus and the data collecting apparatus, and timing information corresponding to the orientation information, and the executing portion may configure the orientation of at least one of the learning object, the operating apparatus, and the data collecting apparatus according to the orientation information and the timing information.

In the configuring apparatus, optionally, the operating apparatuses may be arranged in plurality. The configuring instruction may comprise: identification information of an operating apparatus selected from a plurality of the operating apparatuses for operating the learning object or the data collecting apparatus, and operation information of operation to be performed by the selected operating apparatus, and the executing portion may instruct the selected operating apparatus to perform the operation according to the identification information and the operation information.

In the configuring apparatus, optionally, the data collecting apparatuses may be arranged in plurality. The configuring instruction may comprise: identification information of a data collecting apparatus selected from a plurality of the data collecting apparatuses for collecting data from the learning object, and operation information of operation performed by the selected data collecting apparatus, and the executing portion may instruct the selected data collecting apparatus to perform the operation according to the identification information and the operation information.

Further, the configuring apparatus according to an embodiment of the present invention may also comprise: an input portion which may receive state information about the learning object, the data collecting apparatus or the operating apparatus, and the configuring instruction generating portion may generate the configuring instruction according to the learning condition information and the state information.

Also further, the configuring apparatus according to an embodiment of the present invention may also comprise: a learning condition information acquiring portion which receives from the outside the learning condition information, or generates the learning condition information according to the commission information, and sends the learning condition information to the configuring instruction generating portion.

According to an embodiment of the present invention, a learning data acquiring apparatus is provided, and may comprise: a configuring apparatus according to an embodiment of the present invention; and a learning data acquiring portion which may acquire learning data about the learning object according to the environment configuration completed by the configuring apparatus.

According to an embodiment of the present invention, a configuring method is provided for configuring a learning object as an objective for acquiring learning data, a data collecting apparatus collecting learning data from the learning object, and an operating apparatus capable of operating the learning object and the data collecting apparatus. The configuration method may comprise: a configuring instruction generating step which may generate a configuring instruction about at least one of the learning object, the data collecting apparatus, and the operating apparatus according to learning condition information, the learning condition information being information generated according to commission information of user commissioned learning; and an executing step which may configure at least one of the learning object, the data collecting apparatus, and the operating apparatus according to the configuring instruction so as to complete an environment configuration for generating the learning data.

In the configuring method, optionally, the learning object may comprise a first learning object and a second learning object. The configuring instruction comprises a switching instruction instructing switch from the first learning object to the second learning object, and the executing step may comprise: switching to the second learning object from the first learning object for data collecting after a predetermined quantity of learning data is generated for the first learning object or a predetermined period has elapsed according to the switching instruction.

Optionally, the configuring instruction may comprise orientation information of at least one of the learning object, the operating apparatus and the data collecting apparatus, and timing information corresponding to the orientation information, and the executing steps may comprise: configuring the orientation of at least one of the learning object, the operating apparatus, and the data collecting apparatus according to the orientation information and the timing information.

In the configuring apparatus, optionally, the operating apparatus may be arranged in plurality. The configuring instruction may comprise: identification information of an operating apparatus selected from a plurality of the operating apparatuses for operating the learning object or the data collecting apparatus, and operation information of operation to be performed by the selected operating apparatus, and the executing step may comprise: instructing the selected operating apparatus to perform the operation according to the identification information and the operation information.

Similarly, the data collecting apparatus may be arranged in plurality. The configuring instruction may comprise: identification information of a data collecting apparatus selected from a plurality of the data collecting apparatuses for collecting data from the learning object, and operation information of operation performed by the selected data selecting apparatus, and the executing step may comprise: instructing the selected data collecting apparatus to perform the operation according to the identification information and the operation information.

Further, the configuring method according to an embodiment of the present invention may also comprise: a state information receiving step which receives state information about the learning object, the data collecting apparatus or the operating apparatus, and the configuring instruction generating step may comprise: generating the configuring instruction according to the learning condition information and the state information.

Also further, the configuring method according to an embodiment of the present invention may also comprise: a learning condition information acquiring step which receives the learning condition information, or generates the learning condition information according to the commission information.

According to an embodiment of the present invention, a learning data acquiring method is provided and may comprise: an environment configuring step which completes an environment configuration for generating the learning data according to the above configuring method; and a learning data acquiring step which acquires learning data about the learning object in the condition of the environment configuration.

According to an embodiment of the present invention, a program is provided for configuring a learning object as an objective for acquiring learning data, a data collecting apparatus collecting learning data from the learning object, and an operating apparatus capable of operating the learning object and the data collecting apparatus, and enables the processor to execute the above configuring method.

According to an embodiment of the present invention, a storing medium is provided, and the storing medium may store the above program.

### Effects of the Invention

The configuring apparatus, method, program, and storing medium according to the embodiments of the present invention generate configuring information for configuring a learning object, a data collecting apparatus and/or an operating apparatus according to the learning condition information, so as to be capable of cooperatively controlling the learning object, the data collecting apparatus and/or the operating apparatus during the process of acquiring the learning data, and greatly reduce the user's burden.

Moreover, compared with the user's manual configuration or modification of various apparatuses related to acquiring the learning data, the configuring apparatus or method according to the embodiments of the present invention may improve the configuration accuracy, improve the learning data quality, and avoid man-made errors which may occur in the configuring process. Besides, the configuring apparatus or method according to the embodiments of the present invention may shorten the processing time, save the system resources of the local computer or the server, and improve the learning data acquiring efficiency.

### BRIEF DESCRIPTION OF DRAWINGS

The drawings illustrated herein constitute a portion of the description for further understanding of the present invention. The illustrative examples of the present invention and description thereof are used for explaining the present invention, and do not constitute inappropriate limitation to the present invention. In the drawings,

FIG. 1 is a schematic view showing a PC as hardware construction realizing a configuring apparatus according to an illustrative embodiment of the present invention;

FIG. 2 is a block diagram showing functional modules of a configuring apparatus according to an illustrative embodiment of the present invention;

FIG. 3 is a block diagram showing functional modules of an object operating apparatus according to an illustrative embodiment of the present invention;

FIG. 4 is a block diagram showing functional modules of a configuring instruction generating portion comprised in a configuring apparatus according to an illustrative embodiment of the present invention;

FIG. 5 is a flow chart showing a configuring method according to an illustrative embodiment of the present invention;

FIG. 6 is a block diagram showing functional modules of a learning data acquiring apparatus according to an illustrative embodiment of the present invention;

FIG. 7 is a flow chart showing a learning data acquiring method according to an illustrative embodiment of the present invention;

FIG. 8 is a schematic view showing a first application example of using a configuring apparatus according to an illustrative embodiment of the present invention;

FIG. 9 is a flow chart showing a configuring method of a first application example; and

FIG. 10 is a schematic view of a second application example of a configuring method according to an illustrative embodiment of the present invention.

### EMBODIMENTS FOR CARRYING OUT THE INVENTION

In order to make the person skilled in the art better understand the present invention, below the embodiments of the present invention will be described clearly and completely in conjunction with figures of the present invention. Apparently, some but not all of embodiments of the present invention are described. Based on the embodiments of the present invention, all the other embodiments, which a person skilled in the art obtains without paying inventive effort, fall within the scope of protection of the present invention.

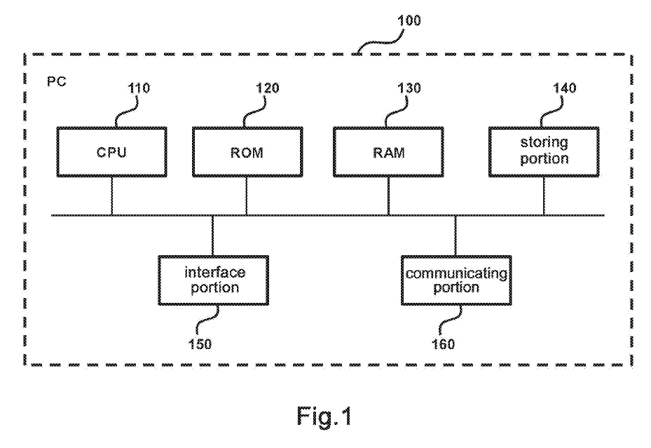

FIG. 1 is a schematic view showing an example of a PC (Personal Computer) 100 as hardware construction realizing a configuring apparatus 200 according to an illustrative embodiment of the present invention. As shown in FIG. 1, this PC 100 may comprise a CPU 110 configured to perform overall control, a Read Only Memory (ROM) 120 configured to store system software, a Random Access Memory (RAM) 130 configured to store written-in/read-out data, a storing portion 140 configured to store various programs and data, an interface portion 150 as an interface of input and output, and a communicating portion 160 configured to realize a communicating function. Substitutionally, the CPU 110 may be replaced by a processor such as a microprocessor MCU or a programmable logic device FPGA. The interface portion 150 may comprise various interfaces such as an input/output interface (I/O interface), a universal serial bus (USB) port (which may be included as one port of ports of the I/O interface), and a network interface. The person ordinarily skilled in the art may understand that the structure shown in FIG. 1 is merely illustrative, and it does not limit the hardware construction of the configuring apparatus 200. For example, the PC 100 further may comprise more or less components than as shown in FIG. 1, or has a configuration different from that shown in FIG. 1.

It should be noted that the above CPU 100 may comprise one or more processors and/or other data processing circuit, all or part of the one or more processors and/or other data processing circuit may be embodied as software, hardware, firmware or any other combinations. Besides, the one or more processors and/or other data processing circuit may be a single independent processing module, or totally or partially combined in any one of the other parts of the PC 100.

The storing portion 140 may be used to store software programs and modules of application software, for example, a program command/data corresponding to a configuring method for configuring a learning object, a data collecting apparatus and/or an operating apparatus, besides, the storing portion 140 also may be used to store commission information, learning data and so on of user commissioned learning. The CPU 110 realizes the above configuring method by running the software programs and modules stored in the storing portion 140. The storing portion 140 may comprise a non-volatile memory, e.g. one or more magnetic storage devices, flash memories, or other non-volatile solid state memories. In some examples, the storing portion 140 may also comprise memories remotely provided with respect to the CPU 110, and these remote memories may be connected to the PC 100 via a network. Examples of the above network includes, but not limited to, internet, intranet, local area network, mobile communication network and combinations thereof.

The interface portion 150 may comprise a touch display (also called as “touch screen”). In some examples, the above touch display may present a graphical user interface (GUI), and the user may make man-machine interaction with the GUI by touching the screen with a finger or a touch pen and/or through a gesture, so as to input the commission information for commission learning and etc. Besides, the user also may understand the situation of the learning data collection through an image shown by the above touch display. An executable command for executing the above man-machine interaction function is configured/stored in one or more processor executable computer program products or readable memory media, for example, it may be stored in the storing portion 140.

The communicating portion 160 is used to receive or send data via a network. Examples of the above network may include a wireless network provided by a communication provider of the PC 100. In one example, the communicating portion 160 may comprise a network interface controller (NIC), which may be connected with other network devices through a base station so that it may communicate with the internet. In one example, the communicating portion 160 may be a radio frequency (RF) module, which is configured to communication with the internet in a wireless manner.

The person skilled in the art may understand that the example as the hardware construction realizing the configuring apparatus 200 according to an illustrative embodiment of the present invention is not limited to the PC 100 shown in FIG. 1, for example, it also may be a terminal device such as intelligent mobile phone (e.g. Android mobile phone, iOS mobile phone), tablet PC, mobile internet device (MID), and PAD. Alternatively, as an example of the hardware construction realizing the configuring apparatus 200 according to an illustrative embodiment of the present invention, various parts in FIG. 1 other than the interface portion 150 also may be located on a server side or on the cloud.

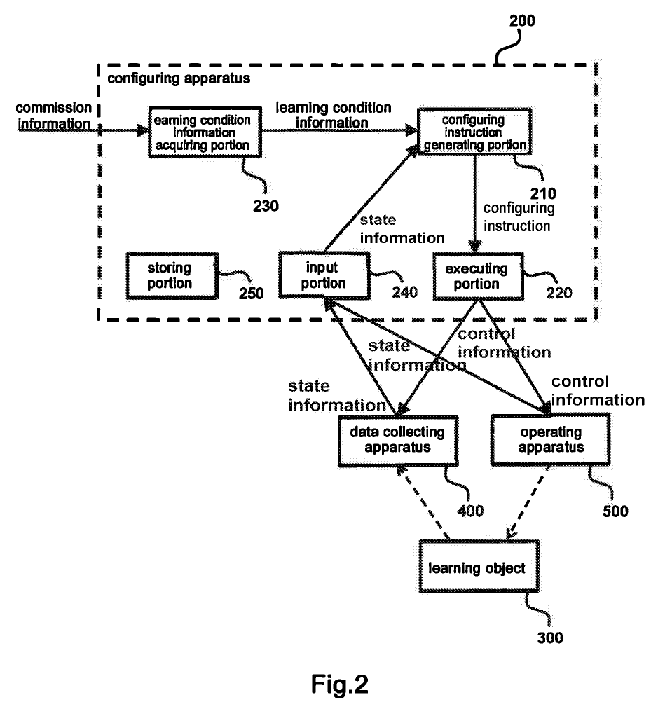

FIG. 2 is a block diagram showing functional modules of the configuration device 200 according to an illustrative embodiment of the present invention. The configuration device 200 is used for configuring a learning object 300 of an objective for acquiring learning data, a data collecting apparatus 400 collecting learning data from the learning object 300, and an operating apparatus 500 capable of operating the learning object 300 and the data collecting apparatus 400, so as to complete an environment configuration for generating learning data. With such an environment configuration, the learning data about the learning object 300 for deep learning is acquired.

An example as the learning object 300 may for example be a workpiece on a production line in a machining plant. An example as the data collecting apparatus 400 may comprise, for example, a camera capturing the workpiece so as to acquire image data, and a sensor detecting the workpiece so as to obtain good product/defective product information. An example as the operating apparatus 500 may comprise, for example, a robot operating the workpiece, a fixture holding and moving the workpiece, and a conveyor belt conveying the workpiece, and may also comprise a robot operating a camera and a sensor. The images of the workpiece and the good product/defective product information thereof serve as learning data, and by means of the related deep learning method, a detecting device on the production line utilizes the learning data for learning so as to acquire the capability of judging whether the workpiece is a good product/defective product.

As shown in FIG. 2, the configuring apparatus 200 according to an illustrative embodiment of the present invention may comprise: a configuring instruction generating portion 210, which generates a configuring instruction about at least one of the learning object 300, the data collecting apparatus 400, and the operating apparatus 500 on the basis of learning condition information, the learning condition information being information generated according to the commission information of user commissioned learning; and an executing portion 220, which configures at least one of the learning object 300, the data collecting apparatus 400, and the operating apparatus 500 so as to complete an environment configuration according to the configuring instruction for generating the learning data.

By providing the configuring instruction generating portion 210, when it is needed to configure for example, the learning object 300, the data collecting apparatus 400, and/or the operating apparatus 500 according to requirements of acquiring the learning data, the configuring apparatus 200 may generate a configuring instruction according to learning condition information so as to automatically complete a configuration operation of those apparatuses, without manual participation, so that the configuration accuracy of the learning object 300, the data collecting apparatus 400 and/or the operating apparatus 500 may be improved, the quality of the acquired learning data is improved, and man-made errors which may occur during the process of configuring those apparatuses is avoided. Besides, the configuring apparatus 200 according to the embodiments of the present invention may shorten the operation time, save the system resources of the local computer or the server, and improve the learning data acquiring efficiency, by cooperating with the operations of various connected apparatuses.

The “commission information” as referred to in the present invention may include various types of information provided by the user used for commission learning. In one optional embodiment, for example, it may include information of the learning object and information of the learning objective. As one example, for example, when judging a workpiece as a good product/defective product on a production line of a machining plant, the learning objective may be enabling a detecting device on the production line to obtain the capability of judging the workpiece as a good product/defective product, or the learning objective may be enabling the detecting device on the production line to obtain the capability of classifying the workpiece, the capability of grading and so on. Of course, the commission information still may include various types of other information as long as the object of the present invention may be realized. For example, the commission information may include information related to the user (consignor) and so on.

Further, as shown in FIG. 2, the configuring apparatus 200 according to an illustrative embodiment of the present invention may also comprise: a learning condition information acquiring portion 230, receiving from outside the learning condition information, or generating the learning condition information according to the commission information provided by users, and sending the learning condition information to the configuring instruction generating portion 210; an input portion 240 receiving state information of the learning object 300, the data collecting apparatus 400 or the operating apparatus 500; and a storing portion 250, storing the learning condition information, and a program/data for generating a configuring instruction according to the learning condition information.

By providing the learning condition information acquiring portion 230, the user may intuitively input the commission information, but does not need to have in-depth understanding to the deep learning technology, therefore, the user operation is simplified, and the difficulty of user using the deep learning technology is reduced. For example, the interface portion 150 described above may include the touch display, this touch display may display the GUI which may interact with the user. As an example, the GUI may prompt the user to input information about accuracy of the learning objective, for example, the learning objective is to enable a detecting device on a production line to have the capability of distinguishing the good product/defective product or to enable the detecting device to have the capability of grading a product as a first-class product/a second-class product/a third-class product/a defective product. The learning condition information acquiring portion 230 may determine information about the quantity of the learning data in the learning condition information, information of a data type of a detecting result obtained by detecting a workpiece and so on.

The person skilled in the art may understand that the configuring apparatus 200 according to an illustrative embodiment of the present invention also may not include the learning condition information acquiring portion 230, for example, the configuring instruction generating portion 210 may receive the learning condition information directly from the outside of the configuring apparatus 200. Likewise, the configuring apparatus 200 according to an illustrative embodiment of the present invention also may not include the storing portion 250, and the program/data and so on for generating a configuring instruction according to the learning condition information may be embedded in the configuring instruction generating portion 210.

The “learning condition information” as referred to in the present invention is information generated according to the commission information of the commission learning provided by the user. In one optional embodiment, for example, the configuring apparatus 200 may comprise a learning condition information database (not shown in the figures) configured to store the learning condition information, and when receiving the commission information from a client, the learning condition information acquiring portion 230 retrieves the learning condition information database for the learning condition information corresponding to the commission information. Substitutionally, the configuring apparatus 200 may store in advance the program configured to generate the learning condition information according to the commission information, and when receiving the commission information, the learning condition information acquiring portion 230 generates the learning condition information corresponding to the commission information using this program. The learning condition information database or a program for generating the learning condition information may be prepared in advance according to the related deep learning technology.

The learning condition information may include various types of information of the learning data about the learning object. In one optional embodiment, for example, the learning condition information may include information about the learning object, the data collecting apparatus, the operating apparatus, the learning objective, the learning data and so on. As an example, the learning condition information may include information about the operating apparatus 500, for example, the type of the operating apparatus 500 (e.g. a robot, a conveyor belt, a fixture, etc.), hardware configuration (e.g. having a plurality of mechanical arms on a robot), a controlling method (e.g. control program of a robot, transport parameter information of a conveyor belt and so on). The configuring instruction generating portion 210 may provide a configuring instruction to the executing portion 220 according to the learning condition information so that the executing portion 220 may provide control information to the operating apparatus 500, and the operating apparatus 500 performs operation on the learning object according to the control information.

The “operating apparatus” as referred to in the present invention may perform operation on the learning object, so as to make the learning object take various actions for generating the learning data, or to realize various states of the learning object and so on. Besides, optionally, the “operating apparatus” as referred to in the present invention still may perform operation on the data collecting apparatus, so as to make the data collecting apparatus take various actions for collecting data from the learning object, or to realize various states and so on.

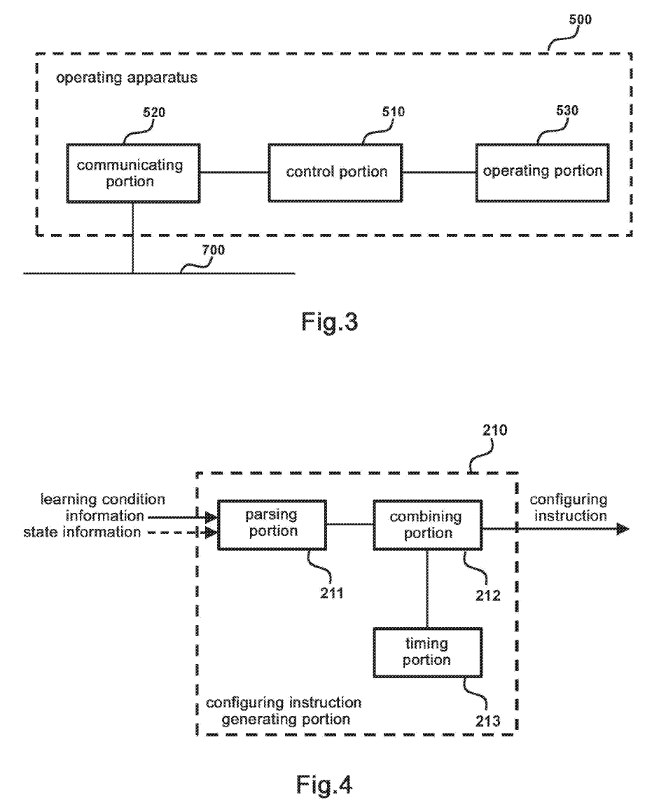

FIG. 3 is a block diagram showing functional modules of the operating apparatus 500 according to an illustrative embodiment of the present invention. As shown in FIG. 3, the operating apparatus 500 may comprise a controlling portion 510, a communicating portion 520 and an operating portion 530. The controlling portion 510 controls in general the operations of various parts of the operating apparatus 500 according to the control information from the configuring apparatus 200. The operating portion 530 may perform operation on the learning object and/or the data collecting apparatus. The communicating portion 520 may communicate with the outside through a local area network 700, for example, receive control information from the configuring apparatus 200, and send the state information of the operating apparatus to the configuring apparatus 200 and so on. Optionally, the communicating portion 520 may also send/receive the information through various other communicating manners, e.g. internet, intranet, mobile communication network and combinations thereof.

As an example, for example, when judging the workpiece as a good product/defective product on the production line of the machining plant, the operating apparatus 500 for example may comprise a robot, and the operating portion 530 for example may comprise one or more mechanical arms of this robot. Optionally, the operating portion 530 may also comprise for example a fixture for clamping workpieces. The controlling portion 510 controls operation of the operating portion 530 on the workpieces according to the control information received by the communicating portion 520 and from the configuring apparatus 200 so as to change the configuration of the workpieces, such as orientation thereof.

The operating apparatus 500 may also perform operation on the data collecting apparatus 400. As an example, although not shown, the data collecting apparatus 400 may comprise one or more cameras capturing workpieces, and a sensor sensing information of the good products/defective products among workpieces. The sensor may be for example an infrared sensor, a weight sensor, a reflective light sensor, etc., to determine whether the workpieces are good products or defective products by means of sensing the temperature, weight, surface conditions, etc., of the workpieces. The controlling portion 510 of the operating apparatus 500 may control, according to the control information received by the communicating portion 520 and from the configuring apparatus 200, the operating portion 530 to configure one or more cameras so as to change the attitude of the cameras for capturing expected images of the workpieces.

In FIG. 2, it is shown that the operating apparatus 500 provides its state information (e.g. orientation information of the mechanical arm) to the configuring apparatus 200, but the present invention is not limited to this. The state information of the operating apparatus 500 also may be provided to the configuring apparatus 200 through the data collecting apparatus 400. For example, the data collecting apparatus 400 may comprise a sensor detecting the operating apparatus 500.

FIG. 4 is a block diagram showing functional modules of the configuring instruction generating portion 210 comprised in the configuring apparatus 200 according to an illustrative embodiment of the present invention. As shown in FIG. 4, the configuring instruction generating portion 210 may comprise: an parsing portion 211 receiving and parsing the learning condition information, and providing the parsed information to a combining portion 212; a timing portion 213 providing the timing information to the combining section 212; and the combining section 212 generating and outputting a configuring instruction according to the parsed information and the timing information.

As an example, for example, the learning condition information may comprise information about the quantity of learning data to be obtained. The parsing portion 211 may make an analysis on the learning condition information, and calculate information about the number of movement times of the workpiece and amount of movement thereof each time such that the combining section 212 may generate, according to the information about the number of movement times of the workpiece and amount of movement thereof each time, in combination with the timing information provided by the timing portion 213, a configuring instruction which controls the number of movement times of the fixture for clamping the workpieces and the amount of movement thereof, and provide the configuring instruction to the operating apparatus 500.

Optionally, the input portion 240 of the configuring apparatus 200 may be input with the state information of the learning object 300, data collecting apparatus 400 or operating apparatus 500, and provide the state information or the processed state information to the configuring instruction generating portion 210. In the configuring instruction generating portion 210, the parsing portion 211 may analyze the learning condition information and the state information, and provide the analyzed information to the combining portion 212, such that the combining portion 212 generates and outputs a configuring instruction according to the analyzed information and timing information.

As an example, for example, the state information may comprise information of the current orientation of the fixture. The parsing portion 211 may analyze the learning condition information and the state information, and calculate the information about the number of movement times of the workpiece and the coordinate of the target for each movement, such that the combining portion 212 may generate, according to the information about the number of movement times of the workpiece and the coordinate of the target for each movement, in combination with the timing information provided by the timing section 213, a configuring instruction for controlling the number of movement times of the fixture used for clamping workpieces and the coordinate of the movement thereof, and provide the configuring instruction to the operating apparatus 500.

Optionally, the timing portion 213 may be combined to the parsing portion 211 or the combining portion 212. As an alternative, the configuring instruction generating portion 210 may not comprise the timing portion 213. When the configuring instruction generating portion 210 does not comprise the timing portion 213, the configuring instruction may not comprise the timing information, and the operating apparatus 500 completes, according to the configuring instruction, a series of operations sequentially.

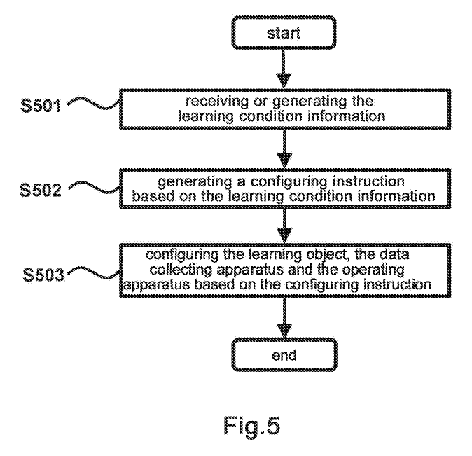

FIG. 5 is a flow chart showing a configuring method according to an illustrative embodiment of the present invention. The configuring method may be used for configuring the learning object 300, the data collecting apparatus 400 and/or the operating apparatus 500. As shown in FIG. 5, in step S501, the learning condition information generating portion 230 receives or generates the learning condition information, and the method proceeds to Step S502. In step S502, the configuring instruction generating portion 201 generates, according to the learning condition information, a configuring instruction about at least one of the learning object 300, the data collecting apparatus 400, and an operating apparatus 500, and the method proceeds to Step S503.

In step S503, the executing portion 220 provides, according to the configuring instruction, control information to the learning object 300, the data collecting apparatus 400 and/or the operating apparatus 500 so as to configure the learning object 300, the data collecting apparatus 400 and/or the operating apparatus 500, thereby completing the environment configuration for generating learning data. Then the flow is ended.

By means of the configuring method, the user may obtain the expected configuration of various apparatuses by merely simply inputting the commission information without man-made configuration of the environment for acquiring the learning data, thereby simplifying the user operation. Even though the user has no understanding of the deep learning technology, the user may also easily utilize the configuring method to acquire the learning data.

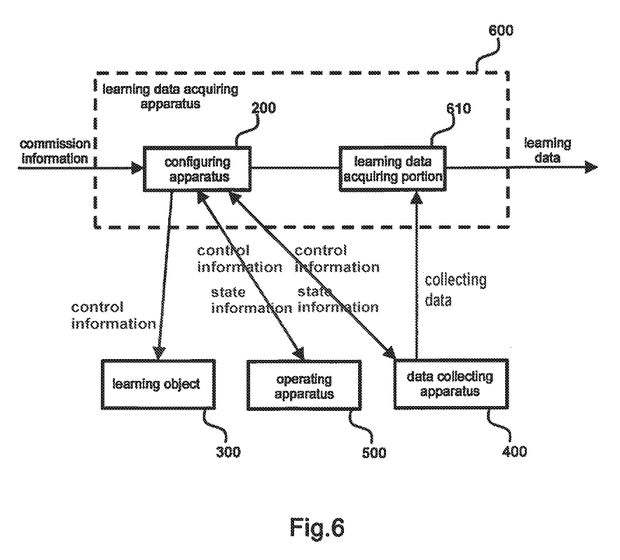

FIG. 6 is a block diagram showing functional modules of the learning data acquiring apparatus 600 according to an illustrative embodiment of the present invention. As shown in FIG. 6, the learning data acquiring apparatus 600 may comprise: a configuring apparatus 200 configuring the learning object 300, the data collecting apparatus 400 and/or the operating apparatus 500 according to the commission information of user commissioned learning and provided by the user (consignor) so as to complete the environment configuration for generating learning data; and a learning data acquiring portion 610 acquiring learning data about the learning object 300 according to the environment configuration completed by the configuring apparatus 200.

For example, the learning data acquiring portion 610 may use the data, for example, the manual of the game of GO, collected by the data collecting apparatus 400, as learning data stored inside the learning data acquiring apparatus 600 or output to outside. The learning data may be used for training a machine so as to have the capability of playing the game of GO. Optionally, the learning data acquiring portion 610 may use the data collected by the data collecting apparatus 400, for example, image data of the workpieces, as a portion of the learning data, and combine same with other information, for example, information input by the user regarding whether the identified workpieces are good products or defective products, as learning data. The learning data may train the machine to have the capability of judging whether the workpieces are good products or defective products.

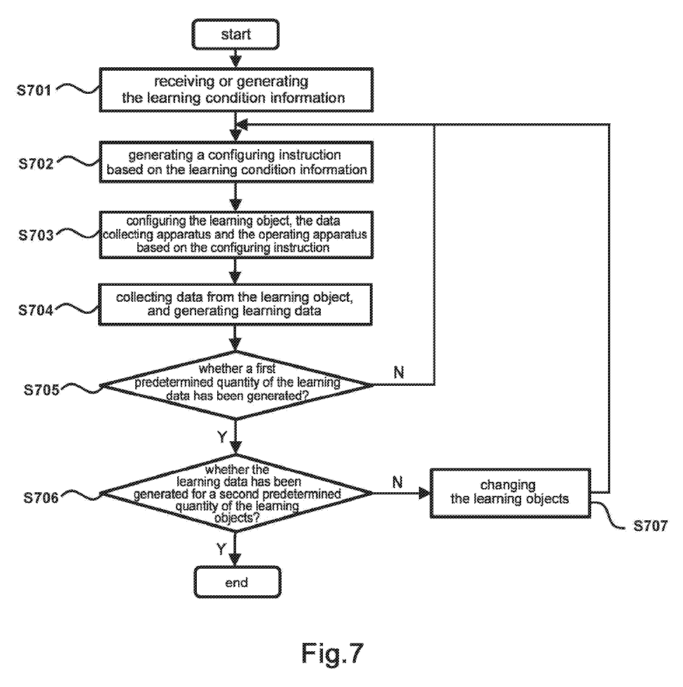

FIG. 7 is a flow chart showing the learning data acquiring method according to an illustrative embodiment of the present invention. Step S701 to step S703 as shown in FIG. 7 may be the same as step S501 to step S503 in the configuring method in FIG. 5 combined in the context. Therefore, the specific explanation of step S701 to step S703 is omitted for avoiding repetition.

In step S704, the learning data acquiring portion 610 receives data collected by the data collecting apparatus 400 from the learning object 300. According to the received data, the learning data is generated and stored inside the learning data acquiring apparatus 600 or is output to outside. The method proceeds to Step S705. In step S705, the learning data acquiring portion 610 determines whether a first predetermined quantity of the learning data has been generated for the current learning object 300. When the first predetermined quantity of the learning data is not generated for the current learning object 300 (S705: NO), it returns back to step S702 of the method, and continues with generation of a next learning data; when the first predetermined quantity of the learning data is generated for the current learning object 300 (S705: YES), the method proceeds to step S706.

In step S706, the learning data acquiring portion 610 determines whether the learning data has been generated for a second predetermined quantity of the learning objects. When no learning data is generated for all the second predetermined quantity of the current learning objects 300 (S706: NO), the method proceeds to step S707; the learning object 300 is changed in step S707, and then the method returns to step S702, and continues with data generation with the next learning object 300; when learning data is generated for all the second predetermined quantity of the current learning objects 300 (S706: YES), the flow is ended.

In the learning data acquiring method as shown in FIG. 7, the configuring information generated by the configuring apparatus is for one learning data, that is, the configuring information of the environment configuration for generating one learning data. Optionally, the configuring information may also be configuring information for a set of learning data, for example, when 10000 learning data will be acquired for the same learning object, the configuring information may comprise the environment configurations respectively required for obtaining the 10000 learning data. At this time, when in step S705, the learning data acquiring portion 610 determines that a first predetermined quantity of the learning data is not generated for the current learning object 300 (S705: NO), it returns back to step S703 of the method, and continues with generation of the next learning data.

Optionally, the configuring information may also be the configuring information for acquiring learning data for a set of learning objects 300, for example, when each of 100 workpieces will acquire 10000 learning data, the configuring information may comprise the environment configurations respectively required for acquiring the 100*10000 learning data. At this time, after the learning object 300 is changed in step S707, the method may proceed to step S703, and continues with generation of learning data for the next learning object 300.

In the learning data acquiring method according to an illustrative embodiment of the present invention as shown in FIG. 7, in step S705, the learning data acquiring portion 610 determines whether a first predetermined quantity of the learning data has been generated. The information of the first predetermined quantity may be a portion of the learning condition information. For example, when the learning data for training the machine to have the capability of grading is obtained, the quantity of learning data required, for example, the first predetermined quantity, is determined according to the grading accuracy information in the commission information input by the user. The information of the first predetermined quantity may be a portion of learning condition information and is used for generating the configuring instruction.

Similarly, the information of the second predetermined quantity in the context may also be a portion of the learning condition information, and is used for generating the configuring instruction. For example, for acquiring the learning data for improving the success rate of grabbing a product having an irregular shape by a robot, the quantity of the products (learning object) as required is determined according to the information of the expected success rate in the commission information input by the user.

In the learning data acquiring method according to an illustrative embodiment of the present invention as shown in FIG. 7, optionally, in Step S705, instead of judging the first predetermined quantity, time also may be judged. For example, in Step S705, the learning data acquiring portion 610 may determine whether the generation of the learning data has been performed for a first predetermined period for the current learning object. If the generation has not been performed for the first predetermined period (a judging result is “NO”), it returns back to Step S702, to continue to generate the next learning data for the current learning object; if the generation has been performed for the first predetermined period (the judging result is “YES”), the method proceeds to Step S706.

Similarly, in step S706, instead of judging the second predetermined quantity, time also may be judged. For example, in step S706, the learning data acquiring portion 610 may determine whether the generation of the learning data is performed for the second predetermined period. If the generation has not been performed for the second predetermined period (a judging result is “NO”), the method proceeds to step S707, and the learning object is changed, and then it returns back to step S702, and continues to generate learning data for the next learning object; if the generation has been performed for the second predetermined period (the judging result is “YES”), the flow is ended.

Optionally, information about the above first predetermined period or the second predetermined period may be included in the learning condition information for generating a configuring instruction. As an example, for example, when the learning data for training the machine to have the capability of judging the quality of radiators is obtained, the time for obtaining the learning data for each radiator is determined according to the accuracy test information in the commission information input by the user. The time information may serve as a portion of the learning condition information and may be used for generating the configuring instruction.

Based on the above learning data acquiring method, the user only needs to input the commission information, and may obtain the interested learning data without being involved in the process of generating the learning data too much. This greatly simplifies the user's operation, so that the user also may utilize the deep learning technology without the need of understanding knowledge such as the deep learning algorithm.

In the learning data acquiring method according to an illustrative embodiment of the present invention as shown in FIG. 7, in step S706, determine whether it is necessary to change the learning object, and in step S707, the learning object is changed. However, the present invention is not limited to this. Alternatively, in step S706, whether it is necessary to change the operating apparatus or data collecting apparatus may be judged, and in step S707, the operating apparatus or data collecting apparatus is changed.

As an example, for example, a plurality of the operating apparatuses 500, for example, a plurality of robots, are arranged. The robots have different capabilities of grabbing different types of workpieces, for example, differences are present in the respects of grabbing success rate and grabbing time. When the user expects to improve the comprehensive processing capabilities of those robots (for example, grabbing a great number of different types of workpieces with an expectation of obtaining an optimal combination of the grabbing success rate and grabbing time), it is necessary to select a certain number of available robots for different types of workpieces and use those robots for operating the workpieces so as to obtain the learning data. The identification information of the selected robots and operation information about the robots operating the workpieces may be included in the configuring information such that the executing portion 220 of the configuring apparatus 200 may send control information to corresponding robots according to the identification information and the operation information so as to instruct the robots to perform the predetermined operation.

As another example, for example, a plurality of data collecting apparatuses 400, for example, a plurality of temperature sensors, are arranged. The temperature sensors are arranged in different orientations. When expecting to obtain an optimal space-temperature change model, the user needs to select some sensors in different orientations for collecting the temperature data so as to obtain the learning data. The identification information of the selected sensors and operation information about the collection operation to be performed by the sensors may be included in the configuring information such that the executing portion 220 of the configuring apparatus 200 may send the control information to corresponding sensors according to the identification information and the operation information so as to instruct the robots to perform the predetermined operation.

Thus, a configuring instruction is generated according to the learning condition information, and a plurality of operating apparatuses or a plurality of data collecting apparatuses are operated/modified according to the configuring instruction, and a complex learning environment may be configured by the configuring apparatus according to an illustrative embodiment of the present invention. A program for generating a configuring instruction according to the learning condition information may be pre-stored in the configuring apparatus by the manufacturer of the configuring apparatuses. The user merely needs to intuitively input the commission information without needing to have more understanding of the details of the environment for generating the learning data or manually operating various apparatuses, thereby saving the manpower and greatly improving the efficiency of obtaining the learning data.

### Application Example 1

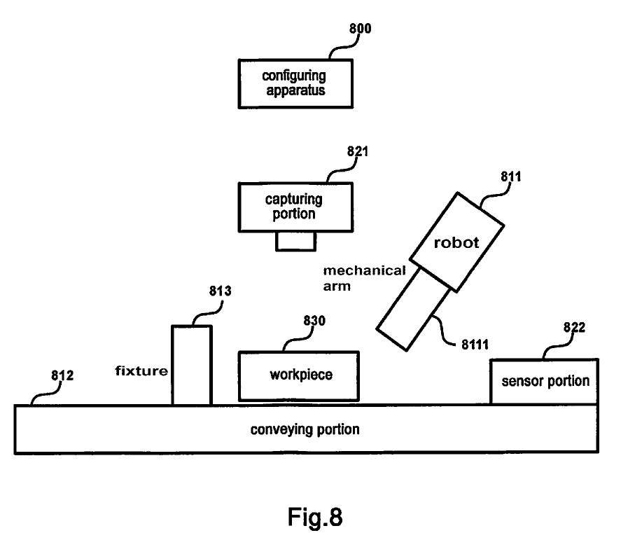

FIG. 8 is a schematic view showing the first application example of the configuring apparatus according to an illustrative embodiment of the present invention. As shown in FIG. 8, the configuring apparatus 800 configures a robot 811, a conveying portion 812, a fixture 813, a capturing portion 821, and a sensor portion 822 on a production line so as to complete the environment configuration for generating learning data, the learning data being used for training the detecting devices (not shown in the figure) on the production line to obtain the capability of judging whether the workpiece 830 is a good product or a defective product.

In FIG. 8, the configuring apparatus 800 is equivalent to the configuring apparatus 200, the workpiece 830 is equivalent to the learning object 300, the capturing portion 820, and the sensor portion 822 are equivalent to the data collecting apparatus 400, and the robot 811, the conveying portion 812, and the fixture 813 are equivalent to the operating apparatus 500. The capturing portion 821 captures the workpiece 830 so as to obtain the image data of the workpiece 830. The sensor portion 822 detects the workpiece 830 so as to obtain the good product/defective product information of the workpiece 830. Alternatively, for example, good product/defective product information of the workpiece 830 may also be manually input by means of human observation of the workpiece 830. The image data and good product/defective product information are a part of learning data.

The robot 811 utilizes the mechanical arm 8111 thereof to operate the workpiece 830, for example, grabbing the workpiece 830 and fixing same to the fixture 813, or removing the workpiece 830 from the fixture 813 and placing same on the conveying portion 812. The conveying portion 812 is used for conveying the workpiece 830. The fixture 813 is used for holding the workpiece 813 and may change the orientation and position of the workpiece 830.

In the configuring apparatus 800, the configuring instruction generating portion (not shown in the figure) may generate a configuring instruction of at least one of the workpiece 830, the robot 811, the conveying portion 812, the fixture 813, the capturing portion 821, and the sensor portion 822 according to the learning condition information, the learning condition information being information generated according to the commission information of user commissioned learning. For example, the program for generating the learning condition information and the program for generating the configuring instruction may be stored in the configuring apparatus 800 in advance by the manufacturer of the configuring apparatus 800.

Further, in the configuring apparatus 800, the execution portion (not shown in figure) configures at least one of the workpiece 830, the robot 811, the conveying portion 812, the fixture 813, the capturing portion 821, and the sensor portion 822 according to the configuring instruction so as to complete the environment configuration for generating the learning data.

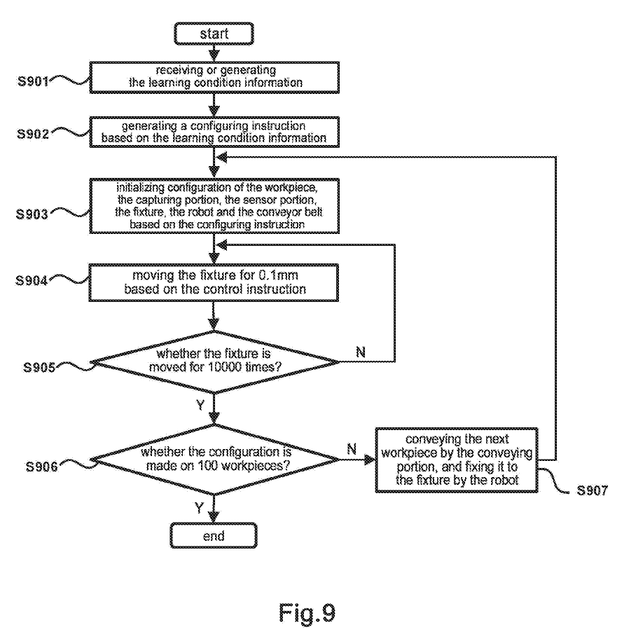

FIG. 9 is a flow chart showing a configuring method of a first application example. As shown in FIG. 9, in step S901, the configuring apparatus 800 receives the commission information provided by the user and used for commissioned learning, and the learning condition information is generated according to the commission information, and the method proceeds to step S902. In step S902, the configuring instruction generating portion (not shown in figure) generates the configuring instructions of the workpiece 830, the robot 811, the conveying portion 812, the fixture 813, the capturing portion 821, and the sensor portion 822 according to the learning condition information, and the method proceeds to step S903. In step S903, the configuring apparatus 800 provides the control information to the robot 811, the conveying portion 812, the fixture 813, the capturing portion 821, and the sensor portion 822 so as to perform initialization operation on these components and the workpiece 830. The initialization operation comprises, for example, fixing the current workpiece 830 on the conveyor belt serving as a learning object to the fixture 813, moving the capturing portion 821 to the initial capturing position and adjusting the capturing orientation, etc.

Thereafter, the method proceeds to step S904. In step S904, the configuring apparatus 800 provides the control information to the robot 811, the fixture 813, the capturing portion 821, and the sensor portion 822 such that the fixture 813 is moved for 0.1 mm, and the capturing portion 821 and the sensor portion 822 are moved correspondingly, and the method proceeds to step S905. In step S905, the configuring apparatus 800 determines whether the fixture 813 is moved for 10000 times. If the fixture 813 is not moved for 10000 times (S905: NO), it returns back to step S904 of the method to continue with the next operation on the fixture 813; if the fixture 813 is moved for 10000 times (S905: YES), the method proceeds to step S906.

In step S906, the configuring apparatus 800 determines whether the above configuration is made on 100 workpieces 830. If the above configuration is not made on the 100 workpieces 830 (S906: NO), the method proceeds to step S907.

In step S907, the configuring apparatus 800 provides the control information to the robot 811, the fixture 813, and the conveying portion 812 so as to utilize the robot 811 to remove the current workpieces 830 from the fixture 813, and fix the next workpiece 830 conveyed by the conveying portion 812 to the fixture 813, and then it returns back to step S903 of the method. A new cycle of configuration is made on new workpieces. In step S906, if the above configuration is made on 100 workpieces (S906: YES), the flow is ended.

In the configuring method of the first application example in FIG. 9, for example, the operation of collecting learning data is performed between step S904 and step S905.

In the above configuring method, according to the user's commission information, a switching instruction is predetermined in the configuring instruction. For example, in step S905, the number of times of movement of the fixture 813 serves as a basis for changing the workpiece 830. In step S906, the quantity of the workpieces serves as a basis for judging whether the method is ended. That is, the switching instruction comprises information of the number of times of configuration of each workpiece (number of learning data obtained as required for each workpiece) and/or the quantity of workpieces, but the present invention is not limited to this. For example, the switching instruction may comprise information of the processing time for each workpiece and/or the total processing time for more workpieces. For example, in step S904, move the fixture 813 once for each 10 seconds. In step S905, the configuring apparatus 800 determines whether 10⁵ seconds expires, which serves as a basis for continuing the movement of the fixture 813.

In addition, in the above configuring method, the robot manipulates the fixture 813 to move for 0.1 mm each time from the initial position to the predetermined orientation, but the present invention is not limited to this, for example, there may be various control modes. For example, the configuring instruction may comprise information (orientation information) of the expected coordinate for each movement of the fixture 813 and the timing information corresponding to the expected coordinate. According to the configuring instruction, the control information provided by the executing portion of the configuring apparatus 800 may be used for controlling the operation of the robot on the fixture 813.

In the above configuring method, as for each workpiece 830, the fixture 813 is moved for 0.1 mm each time for obtaining 10000 learning data. Manual operation may hardly ensure the accuracy, and a large amount of workload may also increase the user's burden. However, the above configuring method automatically completes the environment configuration, thereby saving a great amount of manpower, increasing the configuration accuracy, shortening the configuration time, and saving the system resources.

### Second Application Example

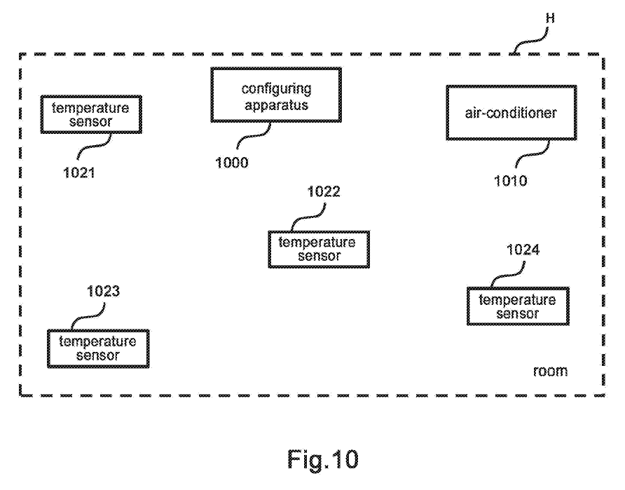

FIG. 10 is a schematic view showing the second application example of a configuring method according to an illustrative embodiment of the present invention. In the second application example, the user expects to obtain a temperature reduction rate model of the whole room during the initialization of an air-conditioner 1010, the temperature reduction rate model may serve as learning data so as to obtain an optimal start control mode of the air-conditioner 1010.

As shown in FIG. 10, a plurality of temperature sensors are arranged in a room H. Four temperature sensors, i.e., temperature sensor 1021 to temperature sensor 1024, are shown in FIG. 10. However, the quantity of temperature sensors is not limited to four, for example, the quantity of temperature sensors may be fewer than or more than four. The temperature sensors 1021 to 1024 are arranged at different positions in the room H, for example, the temperature sensor 1021 is arranged at a place farthest away from the air-conditioner 1010 and with a height the same as the air-conditioner 1010; the temperature sensor 1022 is arranged in the middle of the room H; the temperature sensor 1023 is arranged on the ground farthest away from the air-conditioner 1010; and the temperature sensor 1024 is arranged right below the air-conditioner 1010. The positions for arranging the temperature sensors are not limited to the above, for example, the temperature sensors may be respectively arranged at different heights and with different distances from the air-conditioner 1010.

The configuring instruction generating portion (not shown in figure) of the configuring apparatus 1000 generates a configuring instruction of the temperature sensors 1021 to 1024 according to the learning condition information, the learning condition information being information generated according to the commission information of user commissioned learning. Moreover, the executing portion (not shown in figure) of the configuring apparatus 1000 configures temperature sensors 1021 to 1024 according to the configuring instruction so as to complete the environment configuration for generating learning data.

In the second application example, for example, the above plurality of temperature sensors are fixed at predetermined positions in the room H so as to test the temperatures at the predetermined positions in the room H. The configuring instruction may comprise the timing information and identification information of the temperature sensors corresponding to the timing information so as to select the interested temperature sensor for collecting data within predetermined timing. Optionally, in the second application example, the temperature sensors may be moved to interested positions by means of a robot so as to test the temperature at the interested position. At this time, the configuring instruction may comprise the timing information and the interested coordinate information corresponding to the timing information such that within the predetermined timing, the robot moves the temperature sensors to interested coordinates.

In the second application example, the configuring apparatus 1000 generates a configuring instruction, which may perform automatic configuration on a great number of temperature sensors (for example, 100) without requiring human arrangement or replacement of the sensors. Therefore, the automation level of acquiring the learning data is improved, and the accuracy for obtaining the learning data is saved.

The above is merely for describing the functional modules of the configuring apparatus 200 according to an illustrative embodiment of the present invention. The person skilled in the art may understand that the division of the above functional modules is merely a logical function division, while there may be a plurality of different dividing manners in practical implementation, for example, part or all of the executing portion 220 may be combined or integrated into the configuring instruction generating portion 210. The above functional modules may be physically integrated or separated, they may be located in one place, and also may be distributed onto a plurality of network units, and a suitable implementing manner may be chosen according to practical requirements.

When the above configuring apparatus 200, 800, 1000 or a part thereof, if realized in a form of software functional unit and sold or used as an independent product, may be stored in one computer readable storing medium. Based on such understanding, the technical solution of the present invention essentially or the part making contribution to the prior art or part of this technical solution may be embodied in a form of software product, and this computer software product is stored in one storing medium, including several commands used to make one computer device (which may be a personal computer, a sever, or a network device etc.) execute all or part of Steps of the methods of various examples of the present invention. The aforementioned storing medium includes various media that may store program codes, such as U disk, mobile hard disk, Read-Only Memory (ROM), Random Access Memory (RAM), diskette or compact disk and so on, and also may include data flow which may be downloaded from a server or a cloud.

The above is merely preferred embodiments of the present invention. It should be indicated that for the person ordinarily skilled in the art, several improvements and modifications still may be made without departing from the principle of the present invention, and these improvements and modifications also should be considered as the protection scope of the present invention.

LIST OF REFERENCE SIGNS

| | |
|---|---|
| 100 | PC |
| 110 | CPU |
| 120 | ROM |
| 130 | RAM |
| 140 | storing portion |
| 150 | interface portion |
| 160 | communicating portion |
| 200, 800, 1000 | configuring apparatus |
| 210 | configuring instruction generating portion |
| 220 | executing portion |
| 230 | learning condition information acquiring portion |
| 240 | input portion |
| 250 | storing portion |
| 300 | learning object |
| 400 | data collecting apparatus |
| 500 | operating apparatus |
| 510 | control portion |
| 520 | communicating portion |
| 530 | operating portion |
| 700 | local area network |
| 211 | parsing portion |
| 212 | combining portion |
| 213 | timing portion |
| 600 | learning data acquiring apparatus |
| 610 | learning data acquiring portion |
| 811 | robot |
| 8111 | mechanical arm |
| 812 | conveyor portion |
| 813 | fixture |
| 821 | capturing portion |
| 822 | sensor portion |
| 830 | workpiece |
| 1010 | air-conditioner |
| H | room |
| 1021-1024 | temperature sensor. |

1. A configuring apparatus for configuring a learning object for acquiring learning data, a data collecting apparatus collecting learning data from the learning object, and an operating apparatus capable of operating the learning object and the data collecting apparatus, the configuring apparatus comprising a processor configured with a program to perform operations comprising:
operation as a configuring instruction generating portion configured to generate a configuring instruction about at least one of the learning object, the data collecting apparatus, and the operating apparatus according to learning condition information, the learning condition information being information generated according to commission information of user commissioned learning; and
operation as an executing portion configured to configure at least one of the learning object, the data collecting apparatus, and the operating apparatus according to the configuring instruction so as to complete an environment configuration for generating the learning data.

2. The configuring apparatus according to claim 1, wherein
the learning object comprises a first learning object and a second learning object,
the configuring instruction comprises a switching instruction instructing switch from the first learning object to the second learning object, and
the processor is configured with the program to perform operations such that operation as the executing portion is further configured to switch to the second learning object from the first learning object for data collecting after a predetermined quantity of learning data is generated for the first learning object or a predetermined period has elapsed according to the switching instruction.

3. The configuring apparatus according to claim 1, wherein
the configuring instruction comprises orientation information of at least one of the learning object, the operating apparatus and the data collecting apparatus, and timing information corresponding to the orientation information, and
the processor is configured with the program to perform operations such that operation as the executing portion is further configured to configure the orientation of at least one of the learning object, the operating apparatus, and the data collecting apparatus according to the orientation information and the timing information.

4. The configuring apparatus according to claim 1, wherein
the operating apparatus comprises a plurality of operating apparatuses,
the configuring instruction comprises: identification information of an operating apparatus selected from a plurality of the operating apparatuses for operating the learning object or the data collecting apparatus, and operation information of operation to be performed by the selected operating apparatus, and
the processor is configured with the program to perform operations such that operation as the executing portion is further configured to instruct the selected operating apparatus to perform the operation according to the identification information and the operation information.

5. The configuring apparatus according to claim 1, wherein
the data collecting apparatus comprises a plurality of data collecting apparatuses,
the configuring instruction comprises: identification information of a data collecting apparatus selected from a plurality of the data collecting apparatuses for collecting data from the learning object, and operation information of operation to be performed by the selected data collecting apparatus, and
the processor is configured with the program to perform operations such that operation as the executing portion is further configured to instruct the selected data collecting apparatus to perform the operation according to the identification information and the operation information.

6. The configuring apparatus according to claim 1, wherein
the processor is configured with the program to perform operations further comprising operation as an input portion configured to receive state information about the learning object, the data collecting apparatus or the operating apparatus, and
the processor is configured with the program to perform operations such that operation as the configuring instruction generating portion is further configured to generate the configuring instruction according to the learning condition information and the state information.

7. The configuring apparatus according to claim 1, wherein the processor is configured with the program to perform operations further comprising operation as a learning condition information acquiring portion configured to receive from outside the learning condition information, or generate the learning condition information according to the commission information, and sending the learning condition information to the configuring instruction generating portion.

8. A learning data acquiring apparatus, comprising:
the configuring apparatus according to claim 1, and
a learning data acquiring portion, acquiring learning data about the learning object according to the environment configuration completed by the configuring apparatus.

9. A configuring method for configuring a learning object for acquiring learning data, a data collecting apparatus collecting learning data from the learning object, and an operating apparatus capable of operating the learning object and the data collecting apparatus, the configuring method comprising:
generating a configuring instruction about at least one of the learning object, the data collecting apparatus, and the operating apparatus according to learning condition information, the learning condition information being information generated according to commission information of user commissioned learning; and
configuring at least one of the learning object, the data collecting apparatus, and the operating apparatus according to the configuring instruction so as to complete an environment configuration for generating the learning data.

10. The configuring method according to claim 9, wherein
the learning object comprises a first learning object and a second learning object,
the configuring instruction comprises a switching instruction instructing switch from the first learning object to the second learning object, and
the configuring comprises: switching to the second learning object from the first learning object for data collecting after a predetermined quantity of learning data is generated for the first learning object or a predetermined period has elapsed according to the switching instruction.

11. The configuring method according to claim 9, wherein
the configuring instruction comprises orientation information of at least one of the learning object, the operating apparatus and the data collecting apparatus, and timing information corresponding to the orientation information, and
the configuring comprises: configuring the orientation of at least one of the learning object, the operating apparatus, and the data collecting apparatus according to the orientation information and the timing information.

12. The configuring method according to claim 9, wherein
the operating apparatus comprises a plurality of operating apparatuses,
the configuring instruction comprises: identification information of an operating apparatus selected from a plurality of the operating apparatuses for operating the learning object or the data collecting apparatus, and operation information of operation to be performed by the selected operating apparatus, and
the configuring comprises: instructing the selected operating apparatus to perform the operation according to the identification information and the operation information.

13. The configuring method according to claim 9, wherein
the data collecting apparatus comprises a plurality of data collecting apparatuses,
the configuring instruction comprises: identification information of a data collecting apparatus selected from a plurality of the data collecting apparatuses for collecting data from the learning object, and operation information of operation performed by the selected data collecting apparatus, and
the configuring comprises: instructing the selected data collecting apparatus to perform the operation according to the identification information and the operation information.

14. The configuring method according to claim 9, further comprising:
receiving state information about the learning object, the data collecting apparatus or the operating apparatus, and
the generating comprises: generating the configuring instruction according to the learning condition information and the state information.

15. The configuring method according to claim 9, further comprising:
receiving the learning condition information, or generating the learning condition information according to the commission information.

16. A learning data acquiring method, comprising:
completing an environment configuration for generating the learning data according to the configuring method according to claim 9; and
acquiring learning data about the learning object in the condition of the environment configuration.

17. (canceled)

18. A non-transitory computer-readable storage medium storing a configuring program, the configuring program being used for configuring a learning object for acquiring learning data, a data collecting apparatus collecting learning data from the learning object, and an operating apparatus capable of operating the learning object and the data collecting apparatus, the configuring program, when read and executed, causes a computer to perform operations comprising:
generating a configuring instruction about at least one of the learning object, the data collecting apparatus, and the operating apparatus according to learning condition information, the learning condition information being information generated according to commission information of user commissioned learning; and
configuring at least one of the learning object, the data collecting apparatus, and the operating apparatus according to the configuring instruction so as to complete an environment configuration for generating the learning data.
